(19) United States
(12) Patent Application Publication
(10) Pub. No.: US 2007/0075927 A1
(43) Pub. Date: Apr. 5, 2007

(54) PLASMA DISPLAY APPARATUS AND METHOD OF DRIVING THE SAME

(76) Inventor: Seonghak MOON, Seoul (KR)

Correspondence Address: FLESHNER & KIM, LLP, P.O. BOX 221200, CHANTILLY, VA, 20153, US

(21) Appl. No.: 11/536,982

(22) Filed: Sep. 29, 2006

(30) Foreign Application Priority Data
Sep. 30, 2005 (KR) 10-2005-0092624

(51) Int. Cl. G09G 3/28

(52) U.S. Cl. 345/63

(57) ABSTRACT

A plasma display apparatus and a method of driving the same are disclosed. The plasma display apparatus includes a plasma display panel including a scan electrode, an outside luminance detector, a setup pulse controller and a scan driver. The outside luminance detector detects an outside luminance of the plasma display panel. The setup pulse controller controls a magnitude of the highest voltage of a setup pulse supplied during a reset period in response to a detection signal supplied by the outside luminance detector. The scan driver supplies the setup pulse, whose the magnitude of the highest voltage is controlled in response to a control signal supplied by the setup pulse controller during the reset period, to the scan electrode.

This Nonprovisional application claims priority under 35 U.S.C. § 119(a) on Patent Application No. 10-2005-0092624 filed in Korea on Sep. 30, 2005 the entire contents of which are hereby incorporated by reference.

### BACKGROUND

1. Field

This document relates to a display apparatus, and more particularly, to a plasma display apparatus and a method of driving the same.

2. Description of the Related Art

Out of display apparatuses, a plasma display apparatus comprises a plasma display panel and a driver for driving the plasma display panel.

The plasma display panel comprises a front panel, a rear panel and barrier ribs formed between the front panel and the rear panel. The barrier ribs forms unit discharge cell or discharge cells. Each of discharge cells is filled with a main discharge gas such as neon (Ne), helium (He) and a mixture of Ne and He, and an inert gas containing a small amount of xenon (Xe).

The plurality of discharge cells form one pixel. For example, a red R) discharge cell, a green (G) discharge cell and a blue (B) discharge cell form one pixel.

When the plasma display panel is discharged by a high frequency voltage, the inert gas generates vacuum ultraviolet light, which thereby causes phosphors formed between the barrier ribs to emit light, thus displaying an image. Since the plasma display panel can be manufactured to be thin and light, it has attracted attention as a next generation display device.

### SUMMARY

In one aspect, a plasma display apparatus comprises a plasma display panel comprising a scan electrode, an outside luminance detector for detecting an outside luminance of the plasma display panel a setup pulse controller for controlling a magnitude of the highest voltage of a setup pulse supplied during a reset period in response to a detection signal supplied by the outside luminance detector, and a scan driver for supplying the setup pulse, whose the magnitude of the highest voltage is controlled in response to a control signal supplied by the setup pulse controller during the reset period, to the scan electrode.

In another aspect, a plasma display apparatus comprises a plasma display panel comprising a scan electrode, an outside luminance detector for detecting an outside luminance of the plasma display panel a setup pulse controller for controlling a slope of a setup pulse supplied during a reset period in response to a detection signal supplied by the outside luminance detector, and a scan driver for supplying the setup pulse, whose the slope is controlled in response to a control signal supplied by the setup pulse controller during the reset period, to the scan electrode.

In still another aspect, a plasma display apparatus comprises a plasma display panel comprising a scan electrode, an outside luminance detector for detecting an outside luminance of the plasma display panel a setup pulse controller for controlling a duration of time of the supplying of a setup pulse supplied during a reset period in response to a detection signal supplied by the outside luminance detector, and a scan driver for supplying the setup pulse, whose the duration of time of the supplying is controlled in response to a control signal supplied by the setup pulse controller during the reset period, to the scan electrode.

In yet still another aspect a method of driving a plasma display apparatus displaying an image during a frame comprising a plurality of subfields, the method comprises supplying a first setup pulse to a scan electrode during a reset period of a first frame, and supplying a second setup pulse to the scan electrode during a reset period of a second frame, wherein when an outside luminance of a plasma display panel in the second frame is more than an outside luminance of the plasma display panel in the first frame, a magnitude of the highest voltage of the second setup pulse is less than a magnitude of the highest voltage of the first setup pulse, or a slope of the second setup pulse is less than a slope oft he first setup pulse, or a duration of time of the supplying of the second setup pulse is shorter than a duration of time of the supplying of the first setup pulse.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 illustrates an example of the structure of a plasma display panel of a plasma display apparatus;

FIG. 2 illustrates a method for achieving gray level of an image of the plasma display apparatus;

FIG. 3 illustrates a plasma display apparatus according to a first embodiment;

FIG. 4 illustrates a driving waveform of the plasma display apparatus according to the first embodiment;

FIG. 5 illustrates a plasma display apparatus according to a second embodiment;

FIG. 6 illustrates a driving waveform of the plasma display apparatus according to the second embodiment;

FIG. 7 illustrates a plasma display apparatus according to a third embodiment; and

FIG. 8 illustrates a driving waveform of the plasma display apparatus according to the third embodiment.

### DETAILED DESCRIPTION OF PREFERRED EMBODIMENTS

Reference will now be made in detail embodiments of the invention examples of which are illustrated in the accompanying drawings.

A plasma display apparatus comprises a plasma display panel comprising a scan electrode, an outside luminance detector for detecting an outside luminance of the plasma display panel, a setup pulse controller for controlling a magnitude of the highest voltage of a setup pulse supplied during a reset period in response to a detection signal supplied by the outside luminance detector, and a scan driver for supplying the setup pulse, whose the magnitude of the highest voltage is controlled in response to a control signal supplied by the setup pulse controller during the reset period, to the scan electrode.

The magnitude of the highest voltage of the setup pulse may be inversely proportional to the outside luminance.

The magnitude of the highest voltage of the setup pulse may be controlled in at least one subfield.

The outside luminance detector may comprise an optical sensor.

The outside luminance detector may detect the outside luminance of the plasma display panel in an n-th subfield of each of different frames.

A plasma display apparatus comprises a plasma display panel comprising a scan electrode, an outside luminance detector for detecting an outside luminance of the plasma display panel a setup pulse controller for controlling a slope of a setup pulse supplied during a reset period in response to a detection signal supplied by the outside luminance detector, and a scan driver for supplying the setup pulse, whose the slope is controlled in response to a control signal supplied by the setup pulse controller during the reset period, to the scan electrode.

The slope of the setup pulse may be inversely proportional to the outside luminance.

The slope of the setup pulse may be controlled in at least one subfield.

The outside luminance detector may comprise an optical sensor.

The outside luminance detector may detect the outside luminance of the plasma display panel in an n-th subfield of each of different frames.

A plasma display apparatus comprises a plasma display panel comprising a scan electrode, an outside luminance detector for detecting an outside luminance of the plasma display panel, a setup pulse controller for controlling a duration of time of the supplying of a setup pulse supplied during a reset period in response to a detection signal supplied by the outside luminance detector, and a scan driver for supplying the setup pulse, whose the duration of time of the supplying is controlled in response to a control signal supplied by the setup pulse controller during the reset period, to the scan electrode.

The duration of time of the supplying of the setup pulse may be inversely proportional to the outside luminance.

The duration of time of the supplying of the setup pulse may be controlled in at least one subfield.

The outside luminance detector may comprise an optical sensor.

The outside luminance detector may detect the outside luminance of the plasma display panel in an n-th subfield of each of different frames.

A method of driving a plasma display apparatus displaying an image during a frame comprising a plurality of subfields, the method comprises supplying a first setup pulse to a scan electrode during a reset period of a first frame, and supplying a second setup pulse to the scan electrode during a reset period of a second frame, wherein when an outside luminance of a plasma display panel in the second frame is more than an outside luminance of the plasma display panel in the first frame, a magnitude of the highest voltage of the second setup pulse is less than a magnitude of the highest voltage of the first setup pulse, or a slope of the second setup pulse is less than a slope of the first setup pulse, or a duration of time of the supplying of the second setup pulse is shorter than a duration of time of the supplying of the first setup pulse.

The first frame and the second frame maybe adjacent to each other.

The first frame and the second frame maybe separated from each other.

The first setup pulse is supplied during an n-th subfield of the first frame, and the second setup pulse is supplied during an n-th subfield of the second frame.

Hereinafter, exemplary embodiments of the present invention will be described in detail with reference to the attached drawings.

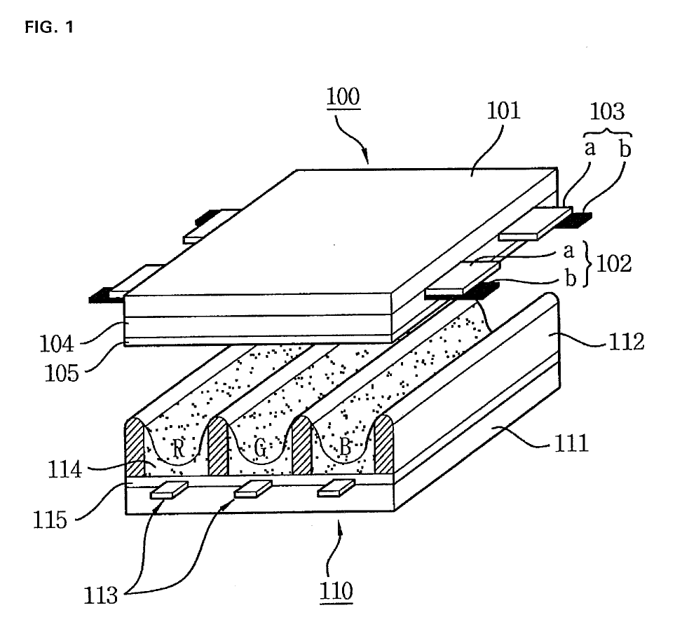

FIG. 1 illustrates an example of the structure of a plasma display panel of a plasma display apparatus.

As illustrated in FIG. 1, the plasma display panel comprises a front panel 100 and a rear panel 110 which are coupled in parallel to oppose to each other at a given distance therebetween

The front panel 100 comprises a front substrate 101 being a display surface on which an image is displayed A plurality of scan electrodes 102 and a plurality of sustain electrodes 103 are formed in pairs on the front substrate 101. The scan electrode 102 and the sustain electrode 103 each comprise transparent electrodes 102a and 103a made of a transparent indium-tin-oxide (ITO) material and bus electrodes 102b and 103b made of a metal material. The scan electrode 102 and the sustain electrode 103 generate a mutual discharge therebetween in one discharge cell and maintain light-emissions of discharge cells.

The scan electrode 102 and the sustain electrode 103 are covered with one or more upper dielectric layers 104 for limiting a discharge current and for providing insulation between the scan electrode 102 and the sustain electrode 103. A protective layer 105 with a deposit of MgO is formed on an upper surface of the upper dielectric layer 104 to facilitate discharge conditions.

The rear panel 110 comprises a rear substrate 111 constituting a rear surface. A plurality of stripe-type (or well-type) barrier ribs 112 are formed in parallel on the rear substrate 111 to form a plurality of discharge spaces (i.e., a plurality of discharge cells).

The plurality of address electrodes 113 for performing an address discharge to generate vacuum ultraviolet light are arranged in parallel to the barrier ribs 112. An upper surface of the rear substrate 111 is coated with Red (R), green (G) and blue (13) phosphors 114 for emitting visible light for an image display when an address discharge is performed

A white dielectric layer 115 is formed between the address electrodes 113 and the phosphors 114 to protect the address electrodes 113 and to reflect visible light emitted from the phosphors 114 on the front panel 100.

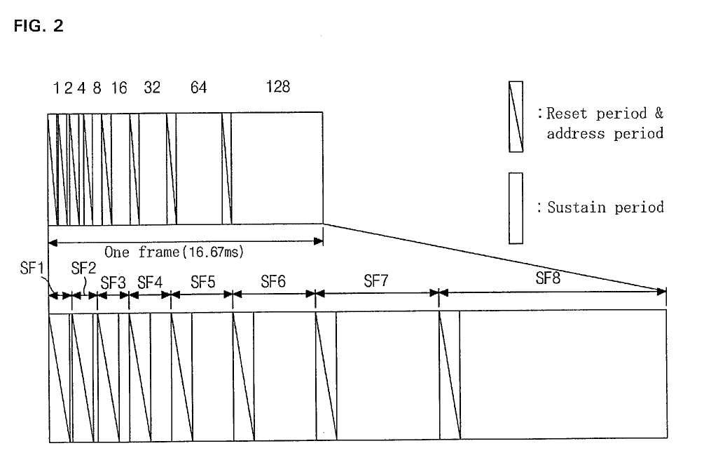

A method for achieving gray level of an image displayed on the plasma display panel is illustrated in FIG. 2.

As illustrated in FIG. 2, the plasma display apparatus is driven by dividing a frame into several subfields having a different number of emission times. Each of the subfields is subdivided into a reset period for initializing the whole screen an address period for selecting a scan line and for selecting a discharge cell from the selected scan line, and a sustain period for representing gray level in accordance with the number of discharges.

For example, if an image with 256 gray level is to be displayed, a frame period (for example, 16.67 ms) corresponding to 1/60sec is divided into eight subfields SF1 to SF8. Each of the eight subfields SF1 to SF8 is subdivided into a reset period, an address period and a sustain period.

A duration of the reset period in a subfield is equal to durations of the reset periods in the remaining subfields. A duration of the address period in a subfield is equal to durations of the address periods in the remaining subfields. A duration of the sustain period increases in a ratio of 2ⁿ(where, n =0, 1, 2, 3, 4, 5, 6, 7) in each of the subfields.

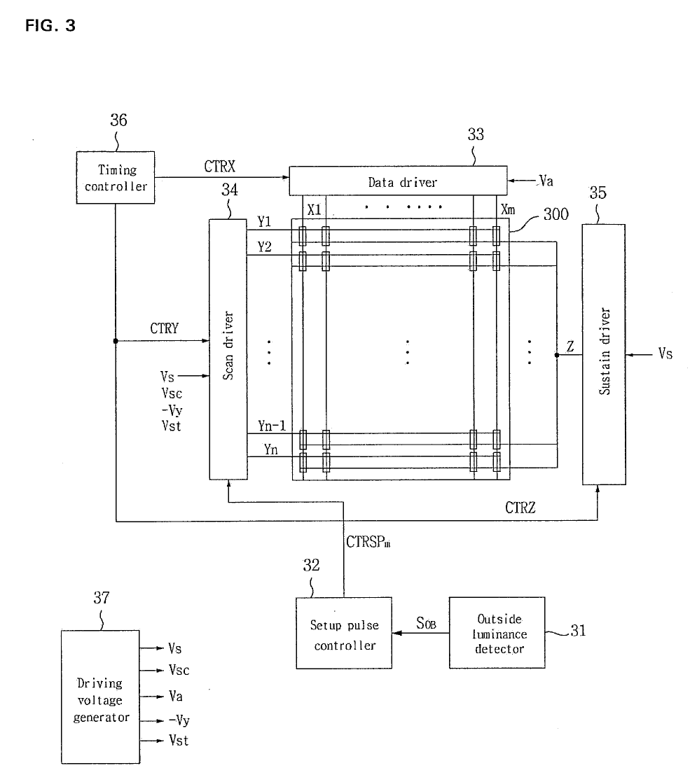

FIG. 3 illustrates a plasma display apparatus according to a first embodiment.

As illustrated in FIG. 3, the plasma display apparatus according to the first embodiment comprises a plasma display panel 300, an outside luminance detector 31, a setup pulse controller 32, a data driver 33, a scan driver 34, a sustain driver 35, a timing controller 36, and a driving voltage generator 37. A gas discharge occurs in a discharge space comprising an inert gas, and thus displaying an image on the plasma display panel 300. The outside luminance detector 31 detects an outside luminance of the plasma display panel 300. The setup pulse controller 32 controls a magnitude of the highest voltage of a setup pulse in response to an outside luminance detection signal SOB supplied by the outside luminance detector 31. The data driver 33 supplies data to address electrodes X1 to Xm formed on a rear panel (not illustrated). The scan driver 34 supplies various pulse voltages including the setup pulse, whose a magnitude is controlled in response to a setup pulse magnitude control signal CTRSPm produced by the setup pulse controller 32, to scan electrodes Y1 to Yn formed on a front panel (not illustrated). The sustain driver 35 drives the sustain electrodes Z formed on the front panel. The fling controller 36 controls the data driver 33, the scan driver 34 and the sustain driver 35. The driving voltage generator 37 supplies a necessary driving voltage to each of the drivers 33, 34 and 35.

A function and an operation of each component of the plasma display apparatus according to the first embodiment will be described in detail below.

The outside luminance detector 31 detects an outside luminance of the plasma display panel 300, for example, a luminance of natural light or a luminance of light emitted from a lighting equipment. Then, the outside luminance detector 31 supplies the outside luminance detection signal SOB to the setup pulse controller 32.

The outside luminance detector 31 may comprise an optical sensor, i.e., a photo diode or a photo transistor.

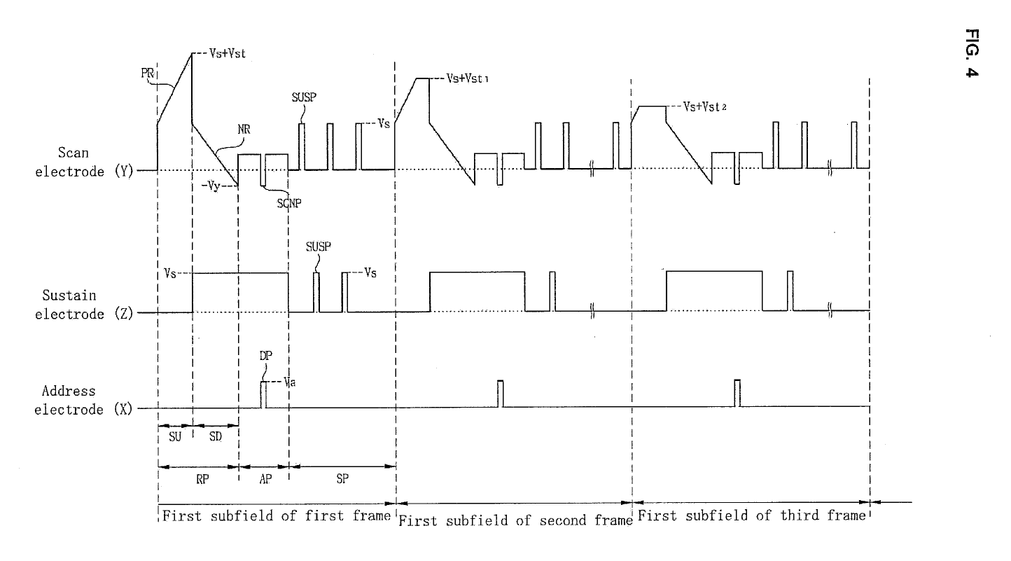

The outside luminance detector 31 detects an outside luminance of the plasma display panel 300 in an n-th subfield of each of different frames. This will be described in detail later with reference to FIG. 4.

The setup pulse controller 32 supplies the setup pulse magnitude control signal CTRSPm for controlling the magnitude of the highest voltage of the setup pulse in response to the outside luminance detection signal SOB supplied by the outside luminance detector 31 to the scan driver 34.

The data driver 33 receives data mapped for each subfield by a subfield mapping circuit (not shown) after being inverse-gamma corrected and error-diffused through an inverse gamma correction circuit (not shown) and an error diffusion circuit (not shown), or the like.

The data driver 33, under the control of the timing controller 36, samples and latches the mapped data, and then supplies the data to the address electrodes X1 to Xm.

The scan driver 34, under the control of the timing controller 36 and the setup pulse controller 32, supplies a setup pulse with a gradually rising voltage, whose a magnitude is controlled in response to the setup pulse magnitude control signal CTRSPm supplied by the setup pulse controller 32, to the scan electrodes Y1 to Yn during a setup period. The scan driver 34 supplies a set-down pulse with a gradually falling voltage to the scan electrodes Y1 to Yn during a set-down period which follows the setup period.

After supplying a reset pulse including the setup pulse and the set-down pulse, the scan driver 34 supplies a scan reference voltage Vsc and a scan pulse falling from the scan reference voltage Vsc to a negative voltage level to the scan electrodes Y1 to Yn during an address period, thereby selecting a scan line.

The scan driver 34 supplies a sustain pulse to the scan electrodes Y1 to Yn during a sustain period, thereby generating a sustain discharge in a discharge cell selected during the address period.

The sustain driver 35, under the control of the timing controller 36, supplies a bias voltage having a sustain voltage level Vs to the sustain electrodes Z during at least a portion of the reset period and the address period. Then, the sustain driver 35 supplies a sustain pulse to the sustain electrodes Z during the sustain period. The scan driver 34 and the sustain driver 35 alternately operate during the sustain period.

The timing controller 36 receives a vertical/horizontal synchronization signal, and generates timing control signals CTRY, CTRY and CTRZ required in each driver 33, 34 and 35. The timing controller 36 supplies the timing control signals CTRX, CTRY and CTRZ to the corresponding drivers 33,34 and 35 to control each driver 33, 34 and 35.

The timing control signal CTRX supplied to the data driver 33 includes a sampling clock for sampling data, a latch control signal, and a switch control signal for controlling on/off time of an energy recovery circuit and a driving switch element.

The timing control signal CTRY supplied to the scan driver 34 includes a switch control signal for controlling the on/off time of an energy recovery circuit and a driving switch element inside the scan driver 34.

The timing control signal CTRZ supplied to the sustain driver 35 includes a switch control signal for controlling on/off time of an energy recovery circuit and a driving switch element inside the sustain driver 35.

The driving voltage generator 37 generates various driving voltages required in each drivers 33, 34, and 35, for example, a sustain voltage Vs, a scan reference voltage Vsc, a data voltage Va, a scan voltage −Vy, a setup voltage Vst. These driving voltages may vary in accordance with the composition of a discharge gas or the structure of the discharge cells.

The following is a detailed description of an operation of the plasma display apparatus according to the first embodiment, with reference to FIG. 4.

FIG. 4 illustrates a driving waveform of the plasma display apparatus according to the first embodiment.

As illustrated in FIG. 4, the plasma display apparatus displays an image by a frame including a plurality of subfields. Each of the subfields includes a reset period RP for initializing all discharge cells, an address period AP for selecting a discharge cell to be discharged, and a sustain period SP for maintaining a discharge of the selected discharge cell.

The following is a detailed description of voltages supplied during each period and a function of each period.

The reset period RP is divided into a setup period SU and a set-down period SD. During the setup period SU, a setup pulse PR with a positive slope is simultaneously supplied to all the scan electrodes Y1 to Yn. The setup pulse PR is an example of a setup waveform, and may adopt various waveforms with a rising form.

The setup pulse PR generates a weak dark discharge (i.e., a setup discharge) within the discharge cells of the whole screen The setup discharge results in wall charges of a positive polarity being accumulated on the address electrodes X1 to Xm and the sustain electrodes Z, and wall charges of a negative polarity being accumulated on the scan electrodes Y1 to Yn.

A setup pulse PR is supplied after controlling a magnitude of the highest voltage of the setup pulse PR depending on an outside luminance of the plasma display panel

Since the setup pulse PR is supplied after controlling the magnitude of the highest voltage of the setup pulse PR depending on the outside luminance of the plasma display panel, the emission amount of black light is controlled depending on an installation environment of the plasma display apparatus, thereby improving a contrast ratio.

It is preferable to control the magnitude of the highest voltage of the setup pulse in at least one subfield. Since the setup pulse PR is supplied after controlling the magnitude of the highest voltage of the setup pulse PR depending on the outside luminance of the plasma display panel in at least one subfield or in all the subfields, the emission amount of black light is controlled depending on the installation environment of the plasma display apparatus, thereby efficiency improving a contrast ratio. Further, a quality for an image display of the plasma display apparatus increases.

It is preferable to control the magnitude of the highest voltage of the setup pulse to be inversely proportional to the outside luminance of the plasma display panel

The outside luminance detector 31 detects the outside luminance of the plasma display panel 300 in the n-th subfields of the different frames. Then, the setup pulse controller 32 controls the magnitude of the highest voltage of the setup pulse to be inversely proportional to the outside luminance of the plasma display panel 300.

For example, the outside luminance detector 31 detects an outside luminance of the plasma display panel in a first subfield of a first frame. A first setup pulse controlled in accordance with the detected outside luminance of the plasma display panel is then supplied

Next, the outside luminance detector 31 detects an outside luminance of the plasma display panel in a first subfield of a second frame. A second setup pulse controlled in accordance with the detected outside luminance of the plasma display panel is then supplied

When the detected outside luminance of the plasma display panel in the first subfield of the second frame is more than the detected outside luminance of the plasma display panel in the first subfield of the first frame, a magnitude (Vs+Vstl) of the highest voltage of the second setup pulse is less than a magnitude (Vs+Vst) of the highest voltage of the first setup pulse.

The first frame maybe adjacent to the second frame, or may be separated from the second frame with different frames being interposed therebetween In other words, the first frame and the second frame may be successively arranged, or the second frame may be a third frame or a fifth frame with different frames being interposed between the first frame and the second frame. The order in which the subfield of the first frame is supplied with the first setup pulse is the same as the order in which the subfield of the second frame is supplied with the second setup pulse.

In FIG. 4, the outside luminance of the plasma display panel is detected in the n-th subfield of each of the different frames such that the magnitude of the highest voltage of the setup pulse is controlled However, the first embodiment is not limited thereto.

The outside luminance of the plasma display panel in the first subfield of the first frame and the outside luminance of the plasma display panel in the first subfield of the second frame were detected in FIG. 4. However, the outside luminance of the plasma display panel in the first subfield of the first frame and an outside luminance of the plasma display panel in a third subfield of the second frame may be detected to control the magnitude of the highest voltage of the setup pulse.

Outside luminances of the plasma display panel in different frames may be detected to control the magnitude of the highest voltage of the setup pulse. Outside luminances of the plasma display panel in different subfields of one frame may be detected to control the magnitude of the highest voltage of the setup pulse.

As described above, when the outside luminance of the plasma display panel is high (i.e., when the plasma display apparatus is installed in a bright room), the magnitude of the highest voltage of the setup pulse lowers to reduce the emission amount of black light. This results in an increase in a contrast ratio and an increase in a quality for an image display of the plasma display apparatus.

During the set-down period SD, a set-down pulse NR with a negative slope is simultaneously supplied to all the scan electrodes Y1 to Yn, and a bias voltage having a positive sustain voltage level Vs is supplied to the sustain electrodes Z. As a result, there is no change in the amount of wall charges of the positive polarity accumulated on the address electrodes X1 to Xm. Further, a portion of the wall charges of the positive polarity accumulated on the sustain electrodes Z is erased because a set-down discharge occurs between the scan electrodes Y1 to Yn and the sustain electrodes Z, and at the same time, a portion of a large amount of wall charges of the negative polarity accumulated on the scan electrodes Y1 to Yn moves to the sustain electrodes Z.

The set-down discharge results in uniformly remaining the wall charges inside the discharge cells to the extent that an address discharge can be stably performed

The set-down pulse NR is an example of a set-down waveform, and may adopt various waveforms with a falling form.

During the address period AP, a scan pulse SCNP falling from a scan reference voltage Vsc to a negative scan voltage −Vy is supplied to the scan electrodes Y1 to Yn, and a data pulse DP rising from a ground level voltage GND to a positive data voltage Va is supplied to the address electrodes X1 to Xm in synchronization with the scan pulse. As the voltage difference between the scan pulse SCNP and the data pulse DP is added to the wall voltage difference between the scan electrodes Y1 to Yn and the address electrodes X1 to Xm using the wall charges remaining during the reset period RP, the address discharge occurs.

A bias voltage having the positive sustain voltage level Vs is supplied to the sustain electrodes Z during the set-down period and the address period AP so that an erroneous discharge does not occur between the sustain electrodes Z and the scan electrodes Y1 to Yn by reducing the voltage difference between the sustain electrodes Z and the scan electrodes Y1 to Yn.

During the sustain period SP, a sustain pulse SUSP rising from a ground level voltage GND to the sustain voltage Vs is alternately supplied to the scan electrodes Y1 to Yn and the sustain electrodes Z.

As the wall voltage within the cells selected by performing the address discharge is added to the sustain pulse SUSP, every time the sustain pulse is applied, a sustain discharge, i.e., a display discharge is generated in the cells selected during the address period.

By performing the above-described driving process, the driving of the plasma display apparatus according to the first embodiment in one subfield is completed.

As described above, the plasma display apparatus according to the first embodiment controls the magnitude of the highest voltage of the setup pulse depending on the outside luminance of the plasma display panel thereby improving the contrast ratio.

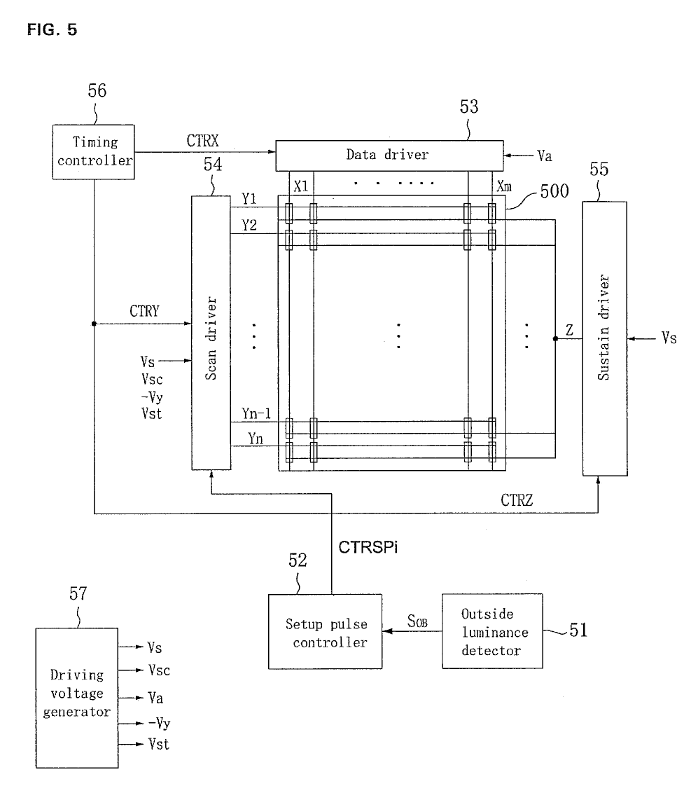

FIG. 5 illustrates a plasma display apparatus according to a second embodiment.

As illustrated in FIG. 5, the plasma display apparatus according to the second embodiment comprises a plasma display panel 500, an outside luminance detector 51, a setup pulse controller 52, a data driver 53, a scan driver 54, a sustain driver 55, a timing controller 56, and a driving voltage generator 57. A gas discharge occurs in a discharge space comprising an inert gas, and thus displaying an image on the plasma display panel 500. The outside luminance detector 51 detects an outside luminance of the plasma display panel 500. The setup pulse controller 52 controls a slope of a setup pulse in response to an outside luminance detection signal SOB supplied by the outside luminance detector 51. The data driver 53 supplies data to address electrodes X1 to Xm formed on a rear panel (not illustrated). The scan driver 54 supplies various pulse voltages including the setup pulse, whose a slope is controlled in response to a setup pulse slope control signal CTRSPi produced by the setup pulse controller 52, to scan electrodes Y1 to Yn formed on a front panel (not illustrated). The sustain driver 55 drives the sustain electrodes Z formed on the front panel The timing controller 56 controls the data driver 53, the scan driver 54 and the sustain driver 55. The driving voltage generator 57 supplies a necessary driving voltage to each of the drivers 53, 54 and 55.

A function and an operation of each component of the plasma display apparatus according to the second embodiment will be described in detail below.

Although it is not illustrated in FIG. 5, the plasma display panel 500 comprises the front panel (not illustrated) and the rear panel (not illustrated) which are coalesced to oppose to each other at a given distance therebetween with the discharge space comprising an inert gas being interposed therebetween On the front panel a plurality of electrodes, for example, the scan electrodes Y1 to Yn and the sustain electrodes Z are formed in pairs. On the rear panel, the address electrodes X1 to Xm are formed to intersect the scan electrodes Y1 to Yn and the sustain electrodes Z.

The outside luminance detector 51 detects an outside luminance of the plasma display panel 500, for example, a luminance of natural light or a luminance of light emitted from a lighting equipment. Then, the outside luminance detector 51 supplies the outside luminance detection signal SOB to the setup pulse controller 52.

The outside luminance detector 51 may comprise an optical sensor, i.e., a photo diode or a photo transistor.

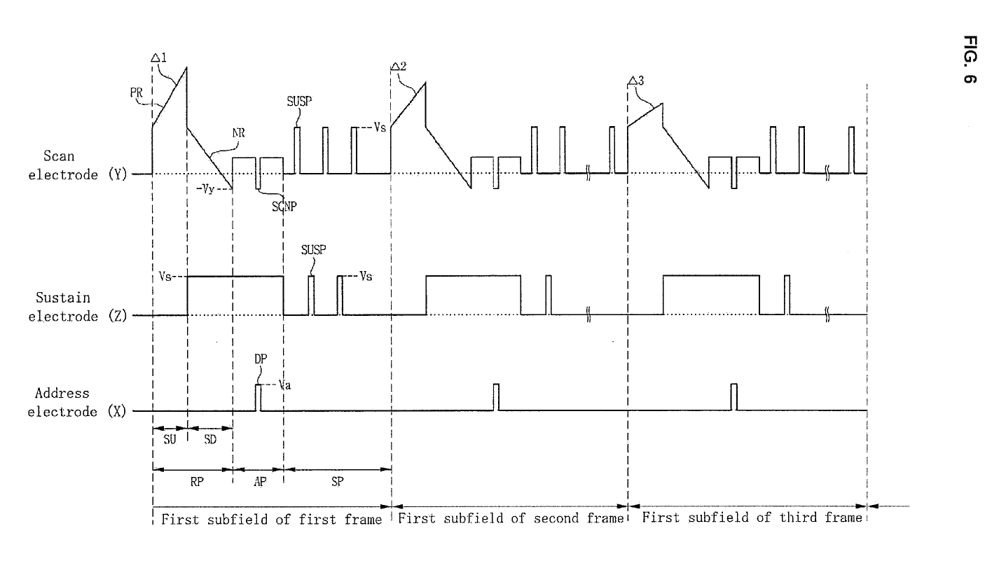

The outside luminance detector 51 detects an outside luminance of the plasma display panel 500 in an n-th subfield of each of different frames. This will be described in detail later with reference to FIG. 6.

The setup pulse controller 52 supplies the setup pulse slope control signal CTRSPi for controlling the slope of the setup pulse in response to the outside luminance detection signal SOB supplied by the outside luminance detector 51 to the scan driver 54.

The data driver 53 receives data mapped for each subfield by a subfield mapping circuit (not shown) after being inverse-gamma corrected and error-diffused through an inverse gamma correction circuit (not shown) and an error diffusion circuit (not shown), or the like.

The data driver 53, under the control of the timing controller 56, samples and latches the mapped data, and then supplies the data to the address electrodes X1 to Xm.

The scan driver 54, under the control of the timing controller 56 and the setup pulse controller 52, supplies a setup pulse, with a gradually rising voltage, whose a slope is controlled in response to the setup pulse slope control signal CTRSPi supplied by the setup pulse controller 52, to the scan electrodes Y1 to Yn during a setup period. The scan driver 54 supplies a set-down pulse with a gradually falling voltage to the scan electrodes Y1 to Yn during a set-down period which follows the setup period.

After supplying a reset pulse including the setup pulse and the set-down pulse, the scan driver 54 supplies a scan reference voltage Vsc and a scan pulse falling from the scan reference voltage Vsc to a negative voltage level to the scan electrodes Y1 to Yn during an address period, thereby selecting a scanline.

The scan driver 54 supplies a sustain pulse to the scan electrodes Y1 to Yn during a sustain period, thereby generating a sustain discharge in a discharge cell selected during the address period.

The sustain driver 55, under the control of the timing controller 56, supplies a bias voltage having a sustain voltage level Vs to the sustain electrodes Z during at least a portion of the reset period and the address period. Then, the sustain driver 55 supplies a sustain pulse to the sustain electrodes Z during the sustain period. The scan driver 54 and the sustain driver 55 alternately operate during the sustain period.

The timing controller 56 receives a vertical/horizontal synchronization signal and generates timing control signals CTRX, CTRY and CTRZ required in each driver 53, 54 and 55. The timing controller 56 supplies the timing control signals CTRX, CTRY and CTRZ to the corresponding drivers 53,54 and 55 to control each driver 53,54 and 55.

The timing control signal CTRX supplied to the data driver 53 includes a sampling clock for sampling data, a latch control signal and a switch control signal for controlling on/off time of an energy recovery circuit and a driving switch element.

The timing control signal CTRY supplied to the scan driver 54 includes a switch control signal for controlling the on/off time of an energy recovery circuit and a driving switch element inside the scan driver 54.

The timing control signal CTRZ supplied to the sustain driver 55 includes a switch control signal for controlling on/off time of an energy recovery circuit and a driving switch element inside the sustain driver 55.

The driving voltage generator 57 generates various driving voltages required in each drivers 53, 54, and 55, for example, a sustain voltage Vs, a scan reference voltage Vsc, a data voltage Va, a scan voltage −Vy, a setup voltage Vst. These driving voltages may vary in accordance with the composition of a discharge gas or the structure of the discharge cells.

The following is a detailed description of an operation of the plasma display apparatus according to the second embodiment, with reference to FIG. 6.

FIG. 6 illustrates a driving waveform of the plasma display apparatus according to the second embodiment.

As illustrated in FIG. 6, the plasma display apparatus displays an image by a frame including a plurality of subfields. Each of the subfields includes a reset period RP for initializing all discharge cells, an address period AP for selecting a discharge cell to be discharged, and a sustain period SP for maintaining a discharge of the selected discharge cell.

The following is a detailed description of voltages supplied during each period and a function of each period.

The reset period RP is divided into a setup period SU and a set-down period SD. During the setup period SU, a setup pulse PR with a positive slope is simultaneously supplied to all the scan electrodes Y1 to Yn. The setup pulse PR is an example of a setup waveform, and may adopt various waveforms with a rising form.

The setup pulse PR generates a weak dark discharge (i.e., a setup discharge) within the discharge cells of the whole screen The setup discharge results in wall charges of a positive polarity being accumulated on the address electrodes X1 to Xm and the sustain electrodes Z, and wall charges of a negative polarity being accumulated on the scan electrodes Y1 to Yn.

The setup pulse PRis supplied after controlling the slope of the setup pulse PR depending on an outside luminance of the plasma display panel

Since the setup pulse is supplied after controlling the slope of the setup pulse PR depending on the outside luminance of the plasma display panel the emission amount of black light is controlled depending on an installation environment of the plasma display apparatus, thereby improving a contrast ratio.

It is preferable to control the slope of the setup pulse in at least one subfield. Since the setup pulse PR is supplied after controlling the slope of the setup pulse PR depending on the outside luminance of the plasma display panel in at least one subfield or in all the subfields, the emission amount of black light is controlled depending on the installation environment of the plasma display apparatus, thereby efficiency improving a contrast ratio. Further, a quality for an image display of the plasma display apparatus increases.

It is preferable to control the slope of the setup pulse to be inversely proportional to the outside luminance of the plasma display panel

The outside luminance detector 51 detects the outside luminance of the plasma display panel 500 in the n-th subfields of the different frames. Then, the setup pulse controller 52 controls the slope of the setup pulse to be inversely proportional to the outside luminance of the plasma display panel 500.

For example, the outside luminance detector 51 detects an outside luminance of the plasma display panel in a first subfield of a first frame. A first setup pulse controlled in accordance with the detected outside luminance of the plasma display panel is then supplied.

Next, the outside luminance detector 51 detects an outside luminance of the plasma display panel in a first subfield of a second frame. A second setup pulse controlled in accordance with the detected outside luminance of the plasma display panel is then supplied

When the detected outside luminance of the plasma display panel in the first subfield of the second frame is more than the detected outside luminance of the plasma display panel in the first subfield of the first frame, a slope (Δ2) of the second setup pulse is less than a slope (Δl) of the first setup pulse.

The first frame may be adjacent to the second frame, or may be separated from the second frame with different frames being interposed therebetween In other words, the first frame and the second frame may be successively arranged, or the second frame may be a third frame or a fifth frame with different frames being interposed between the first frame and the second frame. The order in which the subfield of the first frame is supplied with the first setup pulse is the same as the order in which the subfield of the second frame is supplied with the second setup pulse.

In FIG. 6, the outside luminance of the plasma display panel is detected in the n-th subfield of each of the different frames such that the slope of the setup pulse is controlled. However, the second embodiment is not limited thereto.

The outside luminance of the plasma display panel in the first subfield of the first frame and the outside luminance of the plasma display panel in the first subfield of the second frame were detected in FIG. 6. However, the outside luminance of the plasma display panel in the first subfield of the first frame and an outside luminance of the plasma display panel in a third subfield of the second frame maybe detected to control the slope of the setup pulse.

Outside luminances of the plasma display panel in different frames may be detected to control the slope of the setup pulse. Outside luminances of the plasma display panel in different subfields of one frame may be detected to control the slope of the setup pulse.

As described above, when the outside luminance of the plasma display panel is high (i.e., when the plasma display apparatus is installed in a bright room), the slope of the setup pulse lowers to reduce the emission amount of black light. This results in an increase in a contrast ratio and an increase in a quality for an image display of the plasma display apparatus.

During the set-down period SD, a set-down pulse NR with a negative slope is simultaneously supplied to all the scan electrodes Y1 to Yn, and a bias voltage having a positive sustain voltage level Vs is supplied to the sustain electrodes Z. As a result, there is no change in the amount of wall charges of the positive polarity accumulated on the address electrodes X1 to Xm. Further, a portion of the wall charges of the positive polarity accumulated on the sustain electrodes Z is erased because a set-down discharge occurs between the scan electrodes Y1 to Yn and the sustain electrodes Z, and at the same time, a portion of a large amount of wall charges of the negative polarity accumulated on the scan electrodes Y1 to Yn moves to the sustain electrodes Z.

The set-down discharge results in uniformly remaining the wall charges inside the discharge cells to the extent that an address discharge can be stably performed

The set-down pulse NR is an example of a set-down waveform and may adopt various waveforms with a falling form.

During the address period AP, a scan pulse SCNP falling from a scan reference voltage Vsc to a negative scan voltage −Vy is supplied to the scan electrodes Y1 to Yn, and a data pulse DP rising from a ground level voltage GND to a positive data voltage Va is supplied to the address electrodes X1 to Xm in synchronization with the scan pulse SCNP. As the voltage difference between the scan pulse SCNP and the data pulse DP is added to the wall voltage difference between the scan electrodes Y1 to Yn and the address electrodes X1 to Xm using the wall charges remaining during the reset period RP, the address discharge occurs.

A bias voltage having the positive sustain voltage level Vs is supplied to the sustain electrodes Z during the set-down period and the address period AP so that an erroneous discharge does not occur between the sustain electrodes Z and the scan electrodes Y1 to Yn by reducing the voltage difference between the sustain electrodes Z and the scan electrodes Y1 to Yn.

During the sustain period SP, a sustain pulse SUSP rising from a ground level voltage GND to the sustain voltage Vs is alternately supplied to the scan electrodes Y1 to Yn and the sustain electrodes Z. A s the wall voltage within the cells selected by perfonming the address discharge is added to the sustain pulse SUSP, every time the sustain pulse is applied a sustain discharge, i.e., a display discharge is generated in the cells selected during the address period.

By performing the above-described driving process, the driving of the plasma display apparatus acceding to the second embodiment in one subfield is completed.

As described above, the plasma display apparatus according to the second embodiment controls the slope of the setup pulse depending on the outside luminance of the plasma display panel, thereby improving the contrast ratio.

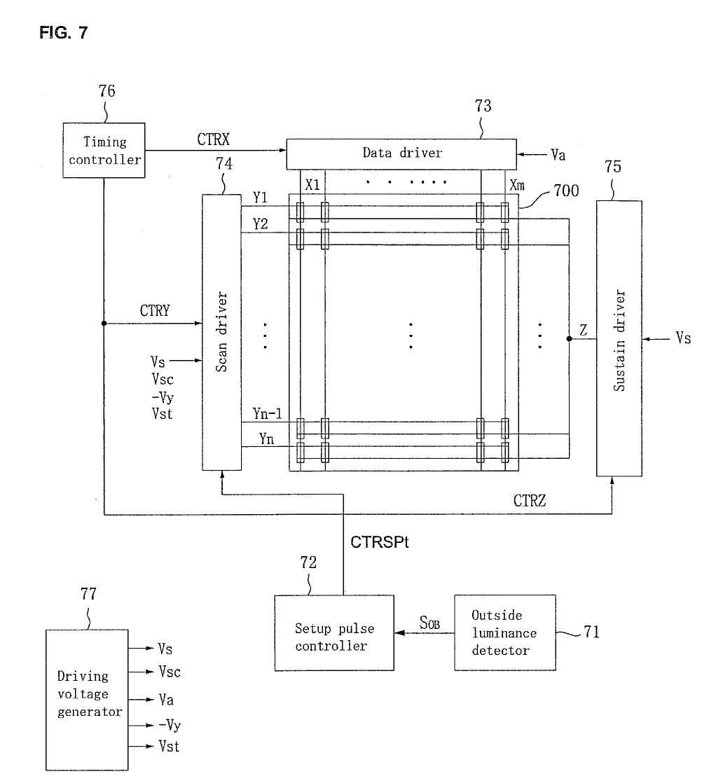

FIG. 7 illustrates a plasma display apparatus according to a third embodiment.

As illustrated in FIG. 7, the plasma display apparatus according to the third embodiment comprises a plasma display panel 700, an outside luminance detector 71, a setup pulse controller 72, a data driver 73, a scan driver 74, a sustain driver 75, a timing controller 76, and a driving voltage generator 77. A gas discharge occurs in a discharge space comprising an inert gas, and thus displaying an image on the plasma display panel 700. The outside luminance detector 71 detects an outside luminance of the plasma display panel 700. The setup pulse controller 72 controls a duration of time of the supplying of a setup pulse in response to an outside luminance detection signal SOB supplied by the outside luminance detector 71. The data driver 73 supplies data to address electrodes X1 to Xm formed on a rear panel (not illustrated). The scan driver 74 supplies various pulse voltages including the setup pulse, whose a duration of time of the supplying is controlled in response to a control signal CTRSPt of the duration of time of the supplying of the setup pulse produced by the setup pulse controller 72, to scan electrodes Y1 to Yn formed on a front panel (not illustrated). The sustain driver 75 drives the sustain electrodes Z formed on the front panel The timing controller 76 controls the data driver 73, the scan driver 74 and the sustain driver 75. The driving voltage generator 77 supplies a necessary driving voltage to each of the drivers 73,74 and 75.

A function and an operation of each component of the plasma display apparatus according to the third embodiment will be described in detail below.

Although it is not illustrated in FIG. 7, the plasma display panel 700 comprises the front panel (not illustrated) and the rear panel (not illustrated) which are coalesced to each other at a given distance therebetween with the discharge space comprising an inert gas being interposed therebetween On the front panel, a plurality of electrodes, for example, the scan electrodes Y1 to Yn and the sustain electrodes Z are formed in pairs. On the rear panel the address electrodes X1 to Xm are formed to intersect the scan electrodes Y1 to Yn and the sustain electrodes Z.

The outside luminance detector 71 detects an outside luminance of the plasma display panel 700, for example, a luminance of natural light or a luminance of light emitted from a lighting equipment. Then, the outside luminance detector 71 supplies the outside luminance detection signal SOB to the setup pulse controller 72.

The outside luminance detector 71 may comprise an optical sensor, i.e., a photo diode or a photo transistor.

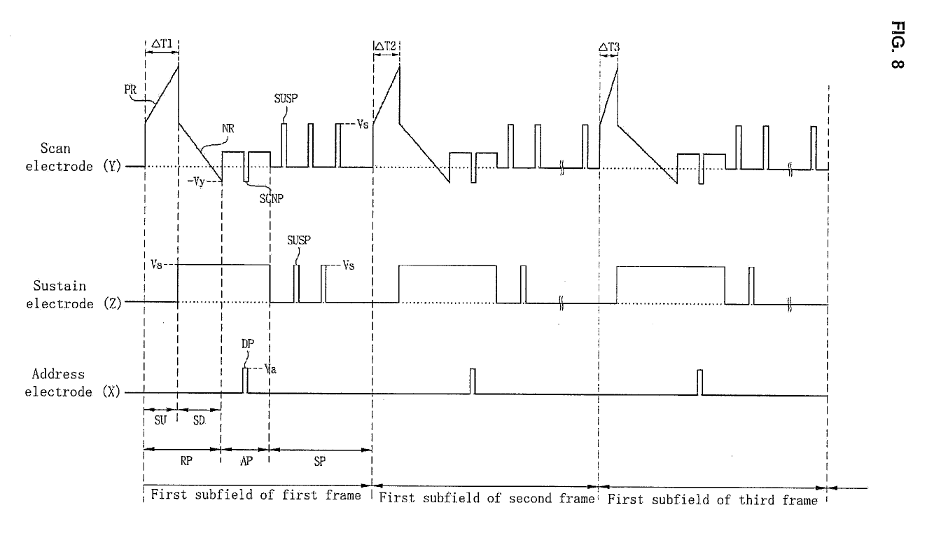

The outside luminance detector 71 detects an outside luminance of the plasma display panel 700 in an n-th subfield of each of different frames. This will be described in detail later with reference to FIG. 8.

The setup pulse controller 72 supplies the control signal CTRSPt for controlling the duration of time of the supplying of the setup pulse in response to the outside luminance detection signal SOB supplied by the outside luminance detector 71 to the scan driver 74.

The data driver 73 receives data mapped for each subfield by a subfield mapping circuit (not shown) after being inverse-gamma corrected and error-diffused through an inverse gamma correction circuit (not shown) and an error diffusion circuit (not shown), or the like.

The data driver 73, under the control of the timing controller 76, samples and latches the mapped data, and then supplies the data to the address electrodes X1 to Xm.

The scan driver 74, under the control of the timing controller 76 and the setup pulse controller 72, supplies a setup pulse, with a gradually rising voltage, whose a duration of time of the supplying is controlled in response to the control signal CTRSPt of the duration of time of the supplying of the setup pulse supplied by the setup pulse controller 72, to the scan electrodes Y1 to Yn during a setup period. The scan driver 74 supplies a set-down pulse with a gradually falling voltage to the scan electrodes Y1 to Yn during a set-down period which follows the setup period.

After supplying a reset pulse including the setup pulse and the set-down pulse, the scan driver 74 supplies a scan reference voltage Vsc and a scan pulse falling from the scan reference voltage Vsc to a negative voltage level to the scan electrodes Y1 to Yn during an address period, thereby selecting a scan in.

The scan driver 74 supplies a sustain pulse to the scan electrodes Y1 to Yn during a sustain period, thereby generating a sustain discharge in a discharge cell selected during the address period.

The sustain driver 75, under the control of the timing controller 76, supplies a bias voltage having a sustain voltage level Vs to the sustain electrodes Z during at least a portion of the reset period and the address period. Then, the sustain driver 75 supplies a sustain pulse to the sustain electrodes Z during the sustain period. The scan driver 74 and the sustain driver 75 alternately operate during the sustain period.

The timing controller 76 receives a, vertical/horizontal synchronization signal, and generates timing control signals CTRY, CTRY and CTRZ required in each driver 73,74 and 75. The timing controller 76 supplies the timing control signals CTRX, CTRY and CTRZ to the corresponding drivers 73, 74 and 75 to control each driver 73, 74 and 75.

The timing control signal CTRX supplied to the data driver 73 includes a sampling clock for sampling data, a latch control signal, and a switch control signal for controlling on/off time of an energy recovery circuit and a driving switch element.

The timing control signal CTRY supplied to the scan driver 74 includes a switch control signal for controlling the on/off time of an energy recovery circuit and a driving switch element inside the scan driver 74.

The timing control signal CTRZ supplied to the sustain driver 75 includes a switch control signal for controlling on/off time of an energy recovery circuit and a driving switch element inside the sustain driver 75.

The driving voltage generator 77 generates various driving voltages required in each drivers 73, 74, and 75, for example, a sustain voltage Vs, a scan reference voltage Vsc, a data voltage Va, a scan voltage −Vy, a setup voltage Vst. These driving voltages may vary in accordance with the composition of a discharge gas or the structure of the discharge cells.

The following is a detailed description of an operation of the plasma display apparatus according to the third embodiment, with reference to FIG. 8.

FIG. 8 illustrates a driving waveform of the plasma display apparatus according to the third embodiment.

As illustrated in FIG. 8, the plasma display apparatus displays an image by a frame including a plurality of subfields. Each of the subfields includes a reset period RP for initializing all discharge cells, an address period AP for selecting a discharge cell to be discharged, and a sustain period SP for maintaining a discharge of the selected discharge cell.

The following is a detailed description of voltages supplied during each period and a function of each period.

The reset period RP is divided into a setup period SU and a set-down period SD. During the setup period SU, a setup pulse PR with a positive slope is simultaneously supplied to all the scan electrodes Y1 to Yn. The setup pulse PR is an example of a setup waveform, and may adopt various waveforms with a rising form.

The setup pulse PR generates a weak dark discharge (i.e., a setup discharge) within the discharge cells of the whole screen The setup discharge results in wall charges of a positive polarity being accumulated on the address electrodes X1 to Xrn and the sustain electrodes Z, and wall charges of a negative polarity being accumulated on the scan electrodes Y1 to Yn.

The setup pulse PR is supplied after controlling the duration of time of the supplying of the setup pulse PR depending on an outside luminance of the plasma display panel

Since the setup pulse is supplied after controlling the duration of time of the supplying of the setup pulse PR depending on the outside luminance of the plasma display panel the emission amount of black light is controlled depending on an installation environment of the plasma display apparatus, thereby improving a contrast ratio.

It is preferable to control the duration of time of the supplying of the setup pulse in at least one subfield. Since the setup pulse PR is supplied after controlling the duration of time of the supplying of the setup pulse PR depending on the outside luminance of the plasma display panel in at least one subfield or in all the subfields, the emission amount of black light is controlled depending on the installation environment of the plasma display apparatus, thereby efficiency improving a contrast ratio. Further, a quality for an image display of the plasma display apparatus increases.

It is preferable to control the duration of time of the supplying of the setup pulse to be inversely proportional to the outside luminance of the plasma display panel

The outside luminance detector 71 detects the outside luminance of the plasma display panel 700 in the n-th subfields of the different frames. Then, the setup pulse controller 32 controls the duration of time of the supplying of the setup pulse to be inversely proportional to the outside luminance of the plasma display panel 700.

For example, the outside luminance detector 71 detects an outside luminance of the plasma display panel in a first subfield of a first frame. A first setup pulse controlled in accordance with the detected outside luminance of the plasma display panel is then supplied

Next, the outside luminance detector 71 detects an outside luminance of the plasma display panel in a first subfield of a second frame. A second setup pulse controlled in accordance with the detected outside luminance of the plasma display panel is then supplied

When the detected outside luminance of the plasma display panel in the first subfield of the second frame is more than the detected outside luminance of the plasma display panel in the first subfield of the first frame, a duration of time (ΔT2) of the supplying of the second setup pulse is shorter than a duration of time (ΔTI) of the supplying of the first setup pulse.

The first frame may be adjacent to the second frame, or may be separated from the second frame with different frames being interposed therebetween In other words, the first frame and the second frame may be successively arranged, or the second frame may be a third frame or a fifth frame with different frames being interposed between the first frame and the second frame. The order in which the subfield of the first frame is supplied with the first setup pulse is the same as the order in which the subfield of the second frame is supplied with the second setup pulse.

In FIG. 8, the outside luminance of the plasma display panel is detected in the n-th subfield of each of the different frames such that the duration of time of the supplying of the setup pulse is controlled However, the third embodiment is not limited thereto.

The outside luminance of the plasma display panel in the first subfield of the first frame and the outside luminance of the plasma display panel in the first subfield of the second frame were detected in FIG. 8. However, the outside luminance of the plasma display panel in the first subfield of the first frame and an outside luminance of the plasma display panel in a third subfield of the second frame may be detected to control the duration of time of the supplying of the setup pulse.

Outside luminances of the plasma display panel in different frames may be detected to control the duration of time of the supplying of the setup pulse. Outside luminances of the plasma display panel in different subfields of one frame maybe detected to control the duration of time of the supplying of the setup pulse.

As described above, when the outside luminance of the plasma display panel is high (i.e., when the plasma display apparatus is installed in a bright room), the duration of time of the supplying of the setup pulse is reduced to reduce the emission amount of black light. This results in an increase in a contrast ratio and an increase in a quality for an image display of the plasma display apparatus.

During the set-down period SD, a set-down pulse NR with a negative slope is simultaneously supplied to all the scan electrodes Y1 to Yn, and a bias voltage having a positive sustain voltage level Vs is supplied to the sustain electrodes Z. As a result, there is no change in the amount of wall charges of the positive polarity accumulated on the address electrodes X1 to Xm. Further, a portion of the wall charges of the positive polarity accumulated on the sustain electrodes Z is erased because a set-down discharge occurs between the scan electrodes Y1 to Yn and the sustain electrodes Z, and at the same time, a portion of a large amount of wall charges of the negative polarity accumulated on the scan electrodes Y1 to Yn moves to the sustain electrodes Z.

The set-down discharge results in uniformly remaining the wall charges inside the discharge cells to the extent that an address discharge can be stably performed

The set-down pulse NR is an example of a set-down waveform, and may adopt various waveforms with a falling form.

During the address period AP, a scan pulse SCNP falling from a scan reference voltage Vsc to a negative scan voltage −Vy is supplied to the scan electrodes Y1 to Yn, and a data pulse DP rising from a ground level voltage GND to a positive data voltage Va is supplied to the address electrodes X1 to Xm in synchronization with the scan pulse SCNP. As the voltage difference between the scan pulse SCNP and the data pulse DP is added to the wall voltage difference between the scan electrodes Y1 to Yn and the address electrodes X1 to Xm using the wall charges remaining during the reset period RP, the address discharge occurs.

A bias voltage having the positive sustain voltage level Vs is supplied to the sustain electrodes Z during the set-down period and the address period AP so that an erroneous discharge does not occur between the sustain electrodes Z and the scan electrodes Y1 to Yn by reducing the voltage difference between the sustain electrodes Z and the scan electrodes Y1 to Yn.

During the sustain period SP, a sustain pulse SUSP rising from a ground level voltage GND to the sustain voltage Vs is alternately supplied to the scan electrodes Y1 to Yn and the sustain electrodes Z. As the wall voltage within the cells selected by performing the address discharge is added to the sustain pulse SUSP, every time the sustain pulse is applied, a sustain discharge, i.e., a display discharge is generated in the cells selected during the address period.

By performing the above-described driving process, the driving of the plasma display apparatus according to the third embodiment in one subfield is completed.

As described above, the plasma display apparatus according to the third embodiment controls the duration of time of the supplying of the setup pulse depending on the outside luminance of the plasma display panel, thereby improving the contrast ratio.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A plasma display apparatus comprising:
a plasma display panel comprising a scan electrode;
an outside luminance detector for detecting an outside luminance of the plasma display panel;
a setup pulse controller for controlling a magnitude of the highest voltage of a setup pulse supplied during a reset period in response to a detection signal supplied by the outside luminance detector; and
a scan driver for supplying the setup pulse, whose the magnitude of the highest voltage is controlled in response to a control signal supplied by the setup pulse controller during the reset period, to the scan electrode.

2. The plasma display apparatus of claim 1, wherein the magnitude of the highest voltage of the setup pulse is inversely proportional to the outside luminance.

3. The plasma display apparatus of claim 1, wherein the magnitude of the highest voltage of the setup pulse is controlled in at least one subfield.

4. The plasma display apparatus of claim 1, wherein the outside luminance detector comprises an optical sensor.

5. The plasma display apparatus of claim 1, wherein the outside luminance detector detects the outside luminance of the plasma display panel in an n-th subfield of each of different frames.

6. A plasma display apparatus comprising:
a plasma display panel comprising a scan electrode;
an outside luminance detector for detecting an outside luminance of the plasma display panel;
a setup pulse controller for controlling a slope of a setup pulse supplied during a reset period in response to a detection signal supplied by the outside luminance detector; and
a scan driver for supplying the setup pulse, whose the slope is controlled in response to a control signal supplied by the setup pulse controller during the reset period, to the scan electrode.

7. The plasma display apparatus of claim 6, wherein the slope of the setup pulse is inversely proportional to the outside luminance.

8. The plasma display apparatus of claim 6, wherein the slope of the setup pulse is controlled in at least one subfield.

9. The plasma display apparatus of claim 6, wherein the outside luminance detector comprises an optical sensor.

10. The plasma display apparatus of claim 6, wherein the outside luminance detector detects the outside luminance of the plasma display panel in an n-th subfield of each of different frames.

11. A plasma display apparatus comprising:
a plasma display panel comprising a scan electrode;
an outside luminance detector for detecting an outside luminance of the plasma display panel;
a setup pulse controller for controlling a duration of time of the supplying of a setup pulse supplied during a reset period in response to a detection signal supplied by the outside luminance detector; and
a scan driver for supplying the setup pulse, whose the duration of time of the supplying is controlled in response to a control signal supplied by the setup pulse controller during the reset period, to the scan electrode.

12. The plasma display apparatus of claim 11, wherein the duration of time of the supplying of the setup pulse is inversely proportional to the outside luminance.

13. The plasma display apparatus of claim 11, wherein the duration of time of the supplying of the setup pulse is controlled in at least one subfield.

14. The plasma display apparatus of claim 11, wherein the outside luminance detector comprises an optical sensor.

15. The plasma display apparatus of claim 11, wherein the outside luminance detector detects the outside luminance of the plasma display panel in an n-th subfield of each of different frames.

16. A method of driving a plasma display apparatus displaying an image during a frame comprising a plurality of subfields, the method comprising:
supplying a first setup pulse to a scan electrode during a reset period of a first frame; and
supplying a second setup pulse to the scan electrode during a reset period of a second frame,
wherein when an outside luminance of a plasma display panel in the second frame is more than an outside luminance of the plasma display panel in the first frame, a magnitude of the highest voltage of the second setup pulse is less than a magnitude of the highest voltage of the first setup pulse, or a slope of the second setup pulse is less than a slope of the first setup pulse, or a duration of time of the supplying of the second setup pulse is shorter than a duration of time of the supplying of the first setup pulse.

17. The method of claim 16, wherein the first frame and the second frame are adjacent to each other.

18. The method of claim 16, wherein the first frame and the second frame are separated from each other.

19. The method of claim 16, wherein the first setup pulse is supplied during an n-th subfield of the first frame, and the second setup pulse is supplied during an n-th subfield of the second frame.
